(19) United States
(12) Patent Application Publication
(10) Pub. No.: US 2008/0190571 A1
(43) Pub. Date: Aug. 14, 2008

(54) Shade Assembly for a Transparent Bodywork Suface of a Vehicle

(76) Inventor: Rudolf Wimmer, Germering (DE)

Correspondence Address: DICKINSON WRIGHT PLLC, 1901 L. STREET NW, SUITE 800, WASHINGTON, DC, 20036, US

(21) Appl. No.: 11/910,658

(22) PCT Filed: Mar. 31, 2006
(86) PCT No.: PCT/DE06/00584

§ 371 Date: Oct. 4, 2007

(30) Foreign Application Priority Data
Apr. 5, 2005 (DE) 10 2005 015 602.9

(51) Int. Cl. B60J 3/02; B60J 7/043

(52) U.S. Cl. 160/310; 296/216.04

(57) ABSTRACT

The invention relates to a shade assembly for a transparent bodywork surface (10) of a vehicle, said assembly comprising at least one section of variable light transmission. The assembly comprises at least one film, whose light transmission characteristics can be modified by the application of an electric current. According to the invention, the film forms part of a displaceable window blind web (12). The invention also relates to a vehicle roof comprising a roof opening, which is closed by a transparent pane (10) and can be shaded by a shade assembly as cited in the invention.

The present invention relates to a shade assembly for a transparent chassis surface of a vehicle according to the preamble of Claim 1 and a vehicle roof according to Claim 19, having a roof opening that is closed by a transparent panel and such a shade device.

The chassis surfaces of motor vehicles are often designed with glass over large areas, especially in the roof area, to achieve a more generous feeling of space in the vehicle interior due to the transparent opening. In order for this gain in comfort not to be counteracted by excessive direct heat or cold exposure and to allow shading of the light, it is expedient to design an automotive chassis surface with suitable glazing in the form of glass panels that can be shaded.

DE 199 62 115 A1 proposes that devices for altering the transparency by applying a voltage, e.g., liquid crystal displays or electrochrome panels, shall be integrated on or within or beneath the windows. These devices offer the advantage of fast and noiseless changes in light transmission on the one hand, and on the other hand, a residual transparency that is perceived as pleasant when shading is employed.

DE 101 30 267 A1 similarly describes transparent sliding roof panels for closing a roof opening in a vehicle roof, with a rigid transparent fixed element arranged beneath the roof, a layer having a transparency that is adjustable by the user of the vehicle via an applied voltage being applied to the underside thereof. This layer may be designed, for example, as a liquid crystal display (LCD), suspended particle device (SPD) or electrochrome (EC) coating on a corresponding panel or as an applied film.

Furthermore, a large-area electrochrome roof surface having an electrically switchable transmission is also known from the Maybach limousine (Maybach 62), which is currently being manufactured.

However, one disadvantage of such rigid elements whose transmission is switchable is the fact that production involves cost-intensive process steps. In many cases, an LCD film is laminated onto the window, but bubbling between the film and the rigid panel increases the incidence of rejects in this process.

Since such an LCD coating is heat sensitive, it is also necessary to apply an additional transparent panel in the area of the transparent chassis surface of the vehicle. The outer glazing is designed without an electrically switchable coating because it can heat up greatly under strong sunlight exposure, which could damage such a coating. Beneath this outer glazing, an inner glazing is provided, having a coating whose transmission is electrically switchable. Such double glazing of the transparent chassis surfaces of vehicles is especially cost-intensive on the one hand, while on the other hand having the disadvantage that the inner glazing must be designed to be displaceable or pivotable to allow removal of particles that may accumulate between the two panes of glazing in the course of use thereof. This requires a complex mechanism and further increases production costs.

Although roller blind assemblies for transparent chassis surfaces of vehicles are also known and provide simple and inexpensive approaches toward shading of transparent surfaces, they do not offer either the convenience of rapid and noiseless changes in light transmission or pleasant lighting conditions and thus the feeling of space that can be achieved with the electrically switchable layers that resemble milk glass when used for shading.

Therefore, the object of the present invention is to create a shade assembly for a transparent chassis surface of a vehicle having at least one area of variable light transmission with which the light transmission is variable by applying an electric voltage but the high manufacturing and maintenance costs of the systems known in the past are reduced.

This object is achieved by a shade assembly according to Claim 1 and a vehicle roof according to Claim 19.

An inventive approach advantageously eliminates the need for a second glazing of the transparent chassis surface of the vehicle to prevent thermal stress on the electrically switchable layer. Instead of such a second glazing, a film having light transmission that is variable by applying an electric voltage is part of a displaceable roller blind. Integrating the film into the roller blind has the advantage that it results in significantly lower production costs. In contrast with the coating of a transparent rigid glazing by a lamination process, for example, or by vapor deposition of a layer of variable transmission, it is much simpler to manufacture a corresponding roller blind. Although a roller blind according to the present invention is usually used in a vehicle in such a way that the roller blind is at mostly pulled out and the transparent chassis surface of the vehicle is covered (whereby the [change in]¹ transmission through the roller blind can be accomplished rapidly and noiselessly by the user without displacement of the roller blind), another important advantage of the present invention consists of the fact that foreign particles such as dust can be removed much more easily from the area between the transparent chassis surface of the vehicle and the transmission regulating layer (the roller blind here). ¹TN: Either this should be “Transmissionsänderung(en)” or the verb should be something other than the present “geschehen kann” (see p. 2, line 15 of source text).

Additional advantageous embodiments of the present invention are derived from the subclaims.

In an especially preferred embodiment of the invention, the shade assembly additionally has a cleaning unit with a gap through which the roller blind is displaceably guided. The opening in the gap is only insignificantly larger than the thickness of the roller blind, so that although tile roller blind can be moved through the gap without applying any great additional force, the gap can strip foreign particles off the roller in the movement of the roller blind through the gap.

Alternatively, such a cleaning unit may also be designed as an edge on one side over which the roller blind is guided, stripping it, so that the edge can strip foreign particles from the side of the roller blind facing it.

In the various additional preferred embodiments of the present invention, a corresponding stripping agent may be designed as a felt strip, an elastic lip or as a brush to improve the stripping performance.

Unlike the roof systems with a variable transmission known from the state of the art, where a large area transparent pane of glass must be moved to clean the element having a variable light transmission, with the embodiments of the present invention described above, the roller blind is easily cleaned by displacing the roller blind and rolling it up.

In other embodiments of the present invention, the film is an electrochrome film, but the use of an LCD film is especially advantageous.

The film may be part of a film laminate having additional films, e.g., transparent films or other electrochrome films, in particular LCD films, for reinforcement.

The section having a variable light transmission may, however, also be designed to consist of a single film if the latter is designed to be stable enough.

In other preferred embodiments of the present invention, the roller blind can be rolled onto a winding shaft, which may also be accommodated in the roller blind housing. When using a shade assembly having a cleaning unit, the cleaning unit is preferably mounted on the roller blind housing in the latter case, which simplifies production and assembly.

The roller blind may also be guided on a transparent panel, which is advantageous in particular when the roller blind should run with a curvature in the longitudinal and/or transverse directions of the vehicle. Again in this case, the switchable film can be cleaned more easily than is the case with the rigidly mounted switchable layers known in the past.

In a further embodiment of the present invention, a lightable film element, in particular an electroluminescence film, may be provided in at least a portion of the area of the roller blind, e.g., along the two side edges of the roller blind. In addition to illuminating the passenger space, any number of decorative effects can be achieved by means of lightable film elements, which have become available in a variety of colors in the meantime. Such lightable film elements can be controlled here by a hand-operated switch or automatically via a sensor device, which detects the brightness in the interior and/or outside of the vehicle.

The present invention is explained in greater detail below on the basis of the accompanying figures in which

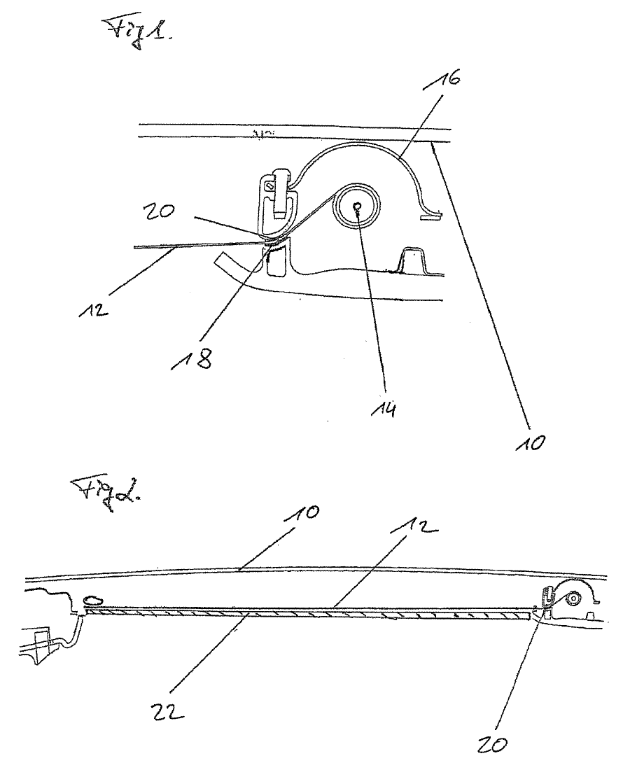

FIG. 1 shows an inventive shade assembly having a roller blind which is composed of an individual self-supporting LCD film, and

FIG. 2 shows an inventive shade assembly in which the roller blind is guided on an additional pane of glass.

FIG. 1 shows a transparent chassis surface of a vehicle in the form of a pane of glass 10 in a sectional view through a roof area of a motor vehicle. The shade assembly has a roller blind 12, designed as an LCD film whose transmission can be varied by applying a voltage to shade the interior of the vehicle from incident light through the pane of glass 10. The roller blind 12 is mounted so that it can be rolled up and down using a winding shaft 14. The voltage supply to the roller blind 12 may be provided via loop contacts of the winding shaft 14 (not shown). The roller blind 12 is guided away from the winding shaft 14 through a gap 20, which is lined on both sides with a felt strip 18. The dimensions of the gap 20 and the two felt strips 18 are such that the roller blind 12 can pass through the gap without any great additional application of force, but on the other hand, the respective felt strip 18 passes over the roller blind on both sides of the gap in such a way that dust or other foreign particles are removed from the roller blind.

Whereas normally the roller blind 12 is unrolled from the winding shaft 14 and thus remains extracted and the transmission through the roller blind can be varied by applying a corresponding electric voltage to it, the roller blind is moved and wound up onto the winding shaft and then unrolled again for cleaning purposes through the gap 20 and/or along the felt strips 18 lining the gap. This cleaning cycle may also be run through several times.

Since the LCD film of the roller blind 12 is not applied directly to the pane of glass 10 on the outside, the thermal burden acting on them with sunlight exposure is greatly reduced. The roller blind 12 may be designed to be extractable both transversely and longitudinally with respect to the direction of travel of the vehicle.

In addition to the embodiment of the roller blind 12 as a self-supporting LCD film, as illustrated in FIG. 1, it may also be desirable to guide such a roller blind along an additional pane of glass 22, as illustrated in FIG. 2. This is advantageous when the roller blind 12 is to be extracted with a curvature in the longitudinal and/or transverse direction of the vehicle. Such a curvature in one direction can be implemented if the pane of glass 22 in FIG. 2 is straight in the direction of extraction of the blind, as illustrated in the figure, but has a curvature above the passenger space in a direction perpendicular to the plane of the figure. Due to the fact that the additional pane of glass 22 runs beneath the roller blind 12, it may in particular also have a curvature when the roller blind is designed to be elastic. The pane of glass and the roller blind thus follow a curved chassis surface of the vehicle.

Due to the inventive embodiment of the roller blind 12 as an LCD layer whose transmission can be varied by applying a voltage, this yields advantages of better cleaning options, because on the one hand the assembly according to FIG. 1 may be furnished with a gap 20 for self-cleaning of the roller blind, while on the other hand, this also permits a reduction in manufacturing costs because a flexible LCD film in the form of a roller blind can be manufactured much less expensively than if the inner pane of glass 22 were to be provided with an LCD layer or another electrochrome layer.

### LIST OF REFERENCE NUMERALS

10 Pane of glass
12 Roller blind
14 Winding shaft
16 Roller blind housing
18 Felt strip
20 Gap
22 Pane of glass

1. Shade assembly for a transparent chassis surface (10) of a vehicle, whereby the shade device has at least one section of variable light transmission with at least one film, the light transmission of which is variable by applying an electric voltage, characterized in that the film is part of a displaceable roller blind (12).

2. Shade assembly according to claim 1, characterized in that it is provided with a cleaning unit having a gap (20) through which the roller blind (12) is guided and having opening which is only insignificantly larger than the thickness of the roller blind.

3. Shade assembly according to claim 2, characterized in that the gap (20) is provided with at least one stripping means (18) which is designed so that it strips foreign particles away from the roller blind on displacement of the latter.

4. Shade assembly according to claim 1, characterized in that a cleaning unit is provided in the form of an edge over which the roller blind (12) is guided across the direction of extraction of the roller blind and which is provided with at least one stripping means that is designed so that it strips foreign particles away from the roller blind on displacement of the latter.

5. Shade assembly according to any one of claims 3 or 4, characterized in that the stripping means is designed as a felt strip (18).

6. Shade assembly according to any one of claims 3 or 4, characterized in that the stripping means is designed as an elastic lip.

7. Shade assembly according to any one of claims 3 or 4, characterized in that the stripping means is designed as a brush.

8. Shade assembly according to any one of the preceding claims, characterized in that the film (12)² is an electrochrome film.
²TN: Previously this number was used for “Rollobahn (12)” [roller blind (12)].

9. Shade assembly according to claim 8, characterized in that the film (12) is an LCD film.

10. Shade assembly according to any one of the preceding claims, characterized in that the film (12) is part of a film laminate, which has at least one additional film that is designed as a transparent film or as a film whose light transmission is variable by applying an electric voltage.

11. Shade assembly according to any one of claims 1 through 9, characterized in that the section of variable light transmission has a single film (12).

12. Shade assembly according to any one of the preceding claims, characterized by a winding shaft (14) onto which the roller blind (12) can be wound.

13. Shade assembly according to claim 12, characterized in that the winding shaft (14) is accommodated in a roller blind housing (16).

14. Shade assembly according to claim 13, referring back to claim 2 or 3, characterized in that the cleaning unit (18, 20) is attached to the roller blind housing (16).

15. Shade assembly according to any one of the preceding claims, characterized in that the roller blind (12) is guided on a transparent pane (22) and is mounted between the latter and the transparent chassis surface (10) of the vehicle.

16. Shade assembly according to claim 13, characterized in that the pane (22) is curved in the longitudinal direction and/or in the transverse direction of the vehicle.

17. Shade assembly according to any one of the preceding claims, characterized in that a lightable film element is provided in at least a partial area of the roller blind (12).

18. Shade assembly according to claim 17, characterized in that the lightable film element has an electroluminescence film.

19. Vehicle roof having a roof opening that is closed by means of a transparent pane (10), and a shade assembly according to any one of the preceding claims.
